(19) United States
(12) Patent Application Publication
(10) Pub. No.: US 2018/0191759 A1
(43) Pub. Date: Jul. 5, 2018

(54) SYSTEMS AND METHODS FOR MODELING AND MONITORING DATA ACCESS BEHAVIOR

(71) Applicant: American Express Travel Related Services Company, Inc., New York, NY (US)

(72) Inventors: Vishal Jaikishore Baijal, Livingston, NJ (US); Anna Bain, East Northfort, NY (US); Debasish Das, New York, NY (US); Sheshidhar Devarapally, Phoenix, AZ (US); Abhisekarn Kumaran Gunnia, Bayonne, NJ (US); Anand K. Indukuri, Phoenix, AZ (US); Sachin Kale, Bangalore (IN); Matthew Meyer, Livingston, NJ (US); Ashok Kumar Nair, Phoenix, AZ (US); Marimuthu Ponnambalam, Phoenix, AZ (US); Jeremy Seideman, Brooklyn, NY (US); Sulabh Shukla, Phoenix, AZ (US)

(73) Assignee: American Express Travel Related Services Company, Inc., New York, NY (US)

(21) Appl. No.: 15/398,200

(22) Filed: Jan. 4, 2017

(51) Int. Cl. H04L 29/06; G06F 17/50; G06F 17/30

(52) U.S. Cl. CPC H04L 63/1425; H04L 63/10; G06F 17/30312; G06F 17/5009

(57) ABSTRACT

A system for monitoring data-access behavior is provided. The system may derive a behavioral pattern based on at least one of historic data access by a user or expected data access by the user. The system may also generate a behavioral model for the user based on the behavioral pattern for the user. In response to detecting a data access activity by the user, the system may compare the data access activity to the behavioral model to determine the data access activity is unusual for the user. The system may further trigger a remediation action in response to determining the data access activity is unusual for the user.

### FIELD

This disclosure relates to systems and methods for data access behavior to detect questionable data access activities.

### BACKGROUND

Large data sets may vary according to size and organization. With big data comprising data sets as large as ever, the volume of data collected incident to the increased popularity of online and electronic transactions continues to grow. Billions of rows and hundreds of thousands of columns worth of data may populate a single table, for example. Different users may desire to access different portions of the large volume of data populating the table. However, different portions of the table may have different security restrictions. For instance, some portions may contain personally identifiable information that should have higher security. Portions of the table and/or the entire table may be encrypted at rest. Different users may have different permissions specific to their roles, identities, and the row and/or column of the table desired to be accessed. However, the size and varied structure of big data sets is often incompatible with traditional data protection techniques.

Moreover, even permitted access by users may lead to an abuse of the system. For example, a user with access to PII may be researching other areas without a proper reason, such as reviewing celebrity spending patterns or examining the personal information of an ex-spouse. Detection of such access would be difficult using manual techniques. Users may also unintentionally misuse data by copying restricted data into folders that have less restrictive access permissions.

### SUMMARY

A system, method, and computer readable medium (collectively, the “system”) is disclosed for monitoring data access using modeled user behavior. The system may derive a behavioral pattern based on at least one of historic data access by a user or expected data access by the user. The system may also generate a behavioral model for the user based on the behavioral pattern for the user. In response to detecting a data access activity by the user, the system may compare the data access activity to the behavioral model to determine that the data access activity is unusual for the user. The system may further trigger a remediation action in response to determining that the data access activity is unusual for the user.

In various embodiments, the system may identify a data source containing sensitive data and analyze access to the data source containing the sensitive data to detect the data access activity. An expert-generated behavioral pattern for the user may be input into the system, with the behavioral model for the user being based on the derived behavioral pattern and the expert-generated behavioral pattern. The system may report a result of the analysis by at least one of an email, a dashboard, or an sms message. The system may also derive a group behavioral pattern based on data access by a group of users, and generate the behavioral model for the user based on the behavioral pattern for the user and the group behavioral pattern.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

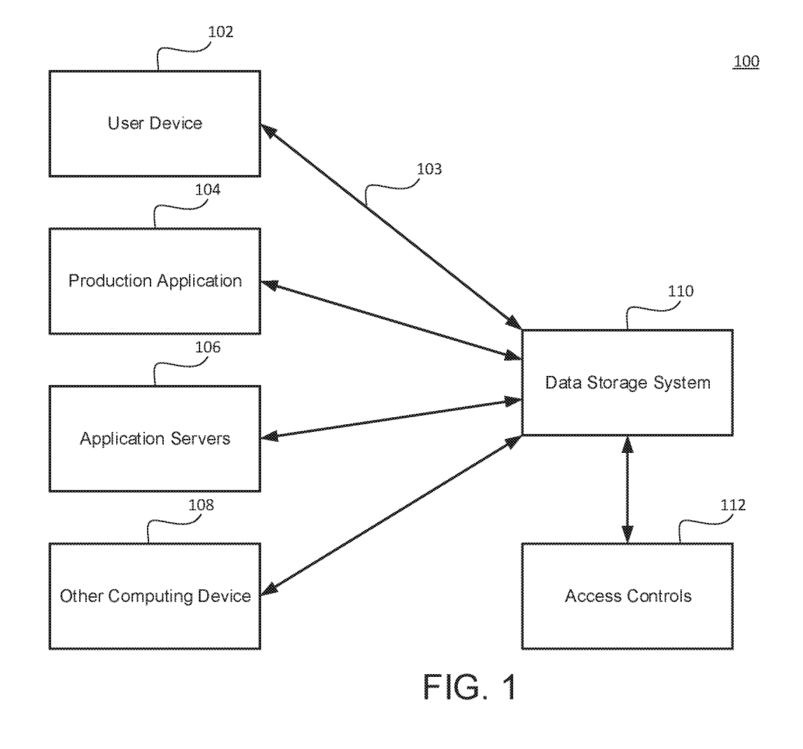

FIG. 1 illustrates an exemplary system for monitoring user behavior in accessing data from a centralized data storage system, in accordance with various embodiments;

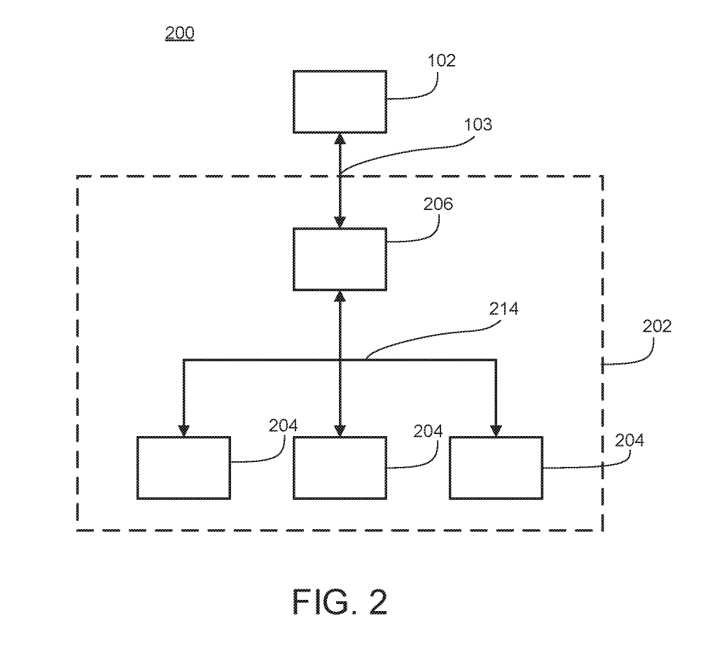

FIG. 2 illustrates an exemplary system for storing, reading, and writing big data sets, in accordance with various embodiments:

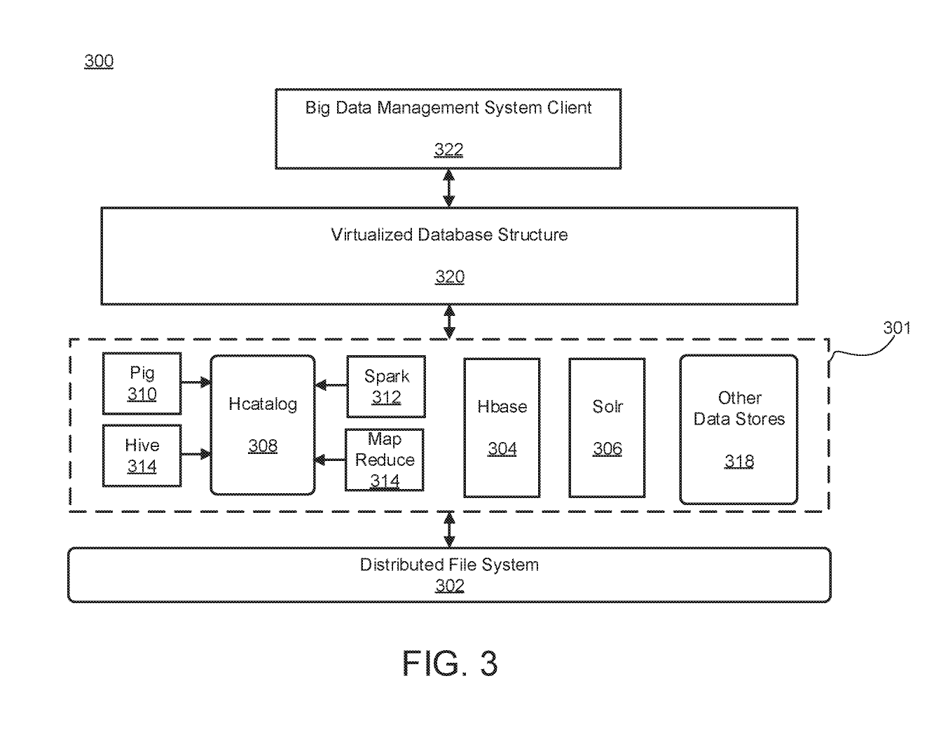

FIG. 3 illustrates an exemplary big data management system supporting a unified, virtualized interface for multiple data storage types, in accordance with various embodiments;

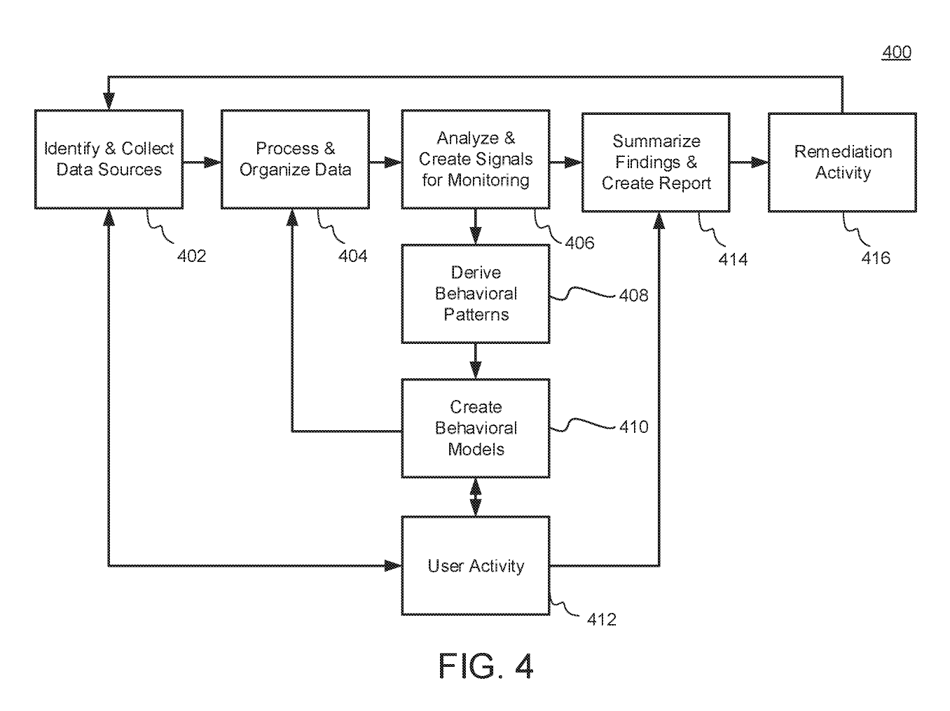

FIG. 4 illustrates an exemplary system for generating data access models and comparing user activity to the data access models, in accordance with various embodiments; and

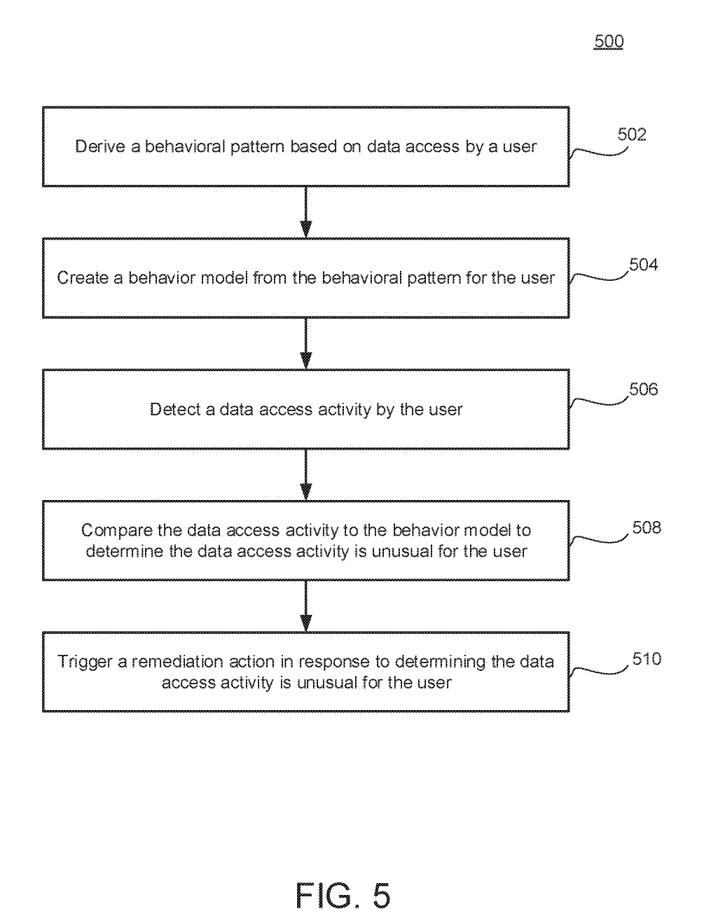

FIG. 5 illustrates an exemplary process for monitoring data access by comparing user activity to the model for the user, in accordance with various embodiments.

### DETAILED DESCRIPTION

The detailed description of various embodiments herein refers to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

As used herein, “big data” may refer to partially or fully structured, semi-structured, or unstructured data sets including hundreds of thousands of columns and records. A big data set may be compiled, for example, from a history of purchase transactions over time, from web registrations, from social media, from records of charge (ROC), from summaries of charges (SOC), from internal data, and/or from other suitable sources. Big data sets may be compiled with or without descriptive metadata such as column types, counts, percentiles, and/or other interpretive-aid data points. The big data sets may be stored in various big-data storage formats containing millions of records (i.e., rows) and numerous variables (i.e., columns) for each record.

Phrases and terms similar to “internal data” and “PII” may include any identifying or sensitive data related to an individual. For example, data that a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location.

The present disclosure provides systems, methods, and computer program products for automating the behavior monitoring process for sensitive data by identifying sensitive data (e.g., personally identifiable information (PII)) and tracking behavior. Behavior may be tracked by monitoring the data elements that users are accessing. The term user may include individuals, application IDs, programs, and/or any other user of data services. By using the data gathered through fine-grained monitoring, the system can recognize patterns in the data and in the user's use history. The system may recognize and/or analyze patterns using history by comparing user activity to known good activity in order to identify outliers by a team, a role, a department, or other user classifications. The system may identify behavior that does not align with the expected behavior identified through training data and expert input. The system may also create a behavioral model of a user to determine the propriety of that behavior by examining the behavior that a user is exhibiting relative to expected behavior for their classifications.

The system may function by identifying users that are actively using a data platform. For each user, the system gathers information such as their command history, process information, and files they own (e.g., correlated into text and program files). The system may also gather use cases associated with each user, which may justify the use of particular data. Next, system scans the user's files for sensitive data and compares the result to the sensitive data that the user is expected to see. Access violations may be detectable in response to the scan.

The system uses automated scanning and evaluation to create a model of user behavior. Users may be identified by specific behavior using their model, and behavior can be labeled as permitted or in violation. By creating these models, behavior can be monitored in a more “real-time” fashion and remediated more quickly. Furthermore, although compatible with a variety of data storage systems and techniques, various embodiments of the systems and methods operate in big data environments, leveraging parallel processing in order to analyze the files, both in large number and large size.

Referring now to FIG. 1, a behavior monitoring system 100 for monitoring data access behavior is shown, in accordance with various embodiments. Behavior monitoring system 100 may include various devices, modules and applications in communication with a data storage system 110 over a network 103. The various devices, modules and applications may include user device 102, production application 104, application servers 106, and/or other computing devices 108. The user device 102, production application 104, application servers 106, and/or other computing devices 108 may include a computer or processor, or a set of computers/processors, such as a personal computer. However, other types of computing units or systems may be used, including laptops, notebooks, hand held computers, personal digital assistants, cellular phones, smart phones (e.g., iPhone®, BlackBerry®, Android®, etc.) tablets, wearables, Internet of Things (IoT) devices, or any other device capable of sending and/or receiving data over the network 103.

A network may be any suitable electronic link capable of carrying communication between two or more computing devices. For example, network 103 may be local area network using TCP/IP communication or wide area network using communication over the Internet. Network 103 may also be an internal network isolated from the Internet. User device 102, production application 104, application servers 106, and/or other computing devices 108 may be in communication with data storage system 110 over network 103.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptography systems.

In various embodiments, data storage system 110 may be also be a computing device or system of computing devices similar to or the same as those described above configured to support data writing and retrieval. For example, data storage system 110 may be a big data system as described below with reference to FIGS. 2 and 3. Data storage system 110 may comprise computing devices and applications to generate data access models for users, as described below. Data storage system 110 may respond to file request (e.g., read and write) received from user device 102, production application 104, application servers 106, and/or other computing devices 108. Data storage system 110 may have access to access controls 112. Access controls 112 may be include a set of access permissions to restrict access to sensitive data based on user, group, machine, application, etc. Access controls may be compatible with portable operating system interface (POSIX) standards and may indicate whether users, groups, etc. are allowed read, write, execute, or other file access. The access permissions may be set at the data type, file level, or any other suitable level.

With reference to FIG. 2, data storage system 110 may be a distributed file system (DFS) 200 as shown, in accordance with various embodiments. DFS 200 comprises a distributed computing cluster 202 configured for parallel processing and storage. Distributed computing cluster 202 may comprise a plurality of nodes 204 in electronic communication with each of the other nodes, as well as a control node 206. Processing tasks may be split among the nodes of distributed computing cluster 202 to improve throughput and enhance storage capacity. Distributed computing cluster may be, for example, a Hadoopl cluster configured to process and store big data sets with some of nodes 204 comprising a distributed storage system and some of nodes 204 comprising a distributed processing system. In that regard, distributed computing cluster 202 may be configured to support a Hadoop® distributed file system (HDFS) as specified by the Apache Software Foundation at http://hadoop.apache.org/docs/.

In various embodiments, nodes 204, control node 206, and user device 102 may comprise any devices capable of receiving and/or processing an electronic message via network 103 and/or network 214. For example, nodes 204 may take the form of a computer or processor, or a set of computers/processors, such as a system of rack-mounted servers. However, other types of computing units or systems may be used, including laptops, notebooks, hand held computers, personal digital assistants, cellular phones, smart phones (e.g., iPhone®, BlackBerry®, Android®, etc.) tablets, wearables (e.g., smart watches and smart glasses), or any other device capable of receiving data over the network.

In various embodiments, user device 102 may submit requests to control node 206. Control node 206 may distribute the tasks among nodes 204 for processing to complete the job intelligently. Control node 206 may limit network traffic and enhance the speed at which incoming data is processed. In that regard, user device 102 may be a separate machine from distributed computing cluster 202 in electronic communication with distributed computing cluster 202 via network 103. Nodes 204 and control node 206 may similarly be in communication with one another over network 214. Network 214 may be an internal network isolated from the Internet and user device 102, or, network 214 may comprise an external connection to enable direct electronic communication with user device 102 and the Internet.

In various embodiments, DFS 200 may process hundreds of thousands of records from a single data source. DFS 200 may also ingest data from hundreds of data sources. Nodes 204 may process the data in parallel to expedite the processing. Furthermore, the transformation and intake of data as disclosed below may be carried out in memory on nodes 204. For example, in response to receiving a source data file of 100,000 records, a system with 100 nodes 204 may distribute the task of processing 1,000 records to each node 204. Each node 204 may then process the stream of 1,000 records while maintaining the resultant data in memory until the batch is complete for batch processing jobs. The results may be written, augmented, logged, and written to disk for subsequent retrieval. The results may be written to disks using various big data storage formats.

With reference to FIG. 3, an exemplary architecture of a big data management system (BDMS) 300 is shown, in accordance with various embodiments. BDMS 300 may be similar to or identical to DFS 200 of FIG. 2, for example. DFS 302 may serve as the physical storage medium for the various data storage formats 301 of DFS 302. A non-relational database 304 may be maintained on DFS 302. For example, non-relational database 304 may comprise an HBase™ storage format that provides random, real time read and/or write access to data, as described and made available by the Apache Software Foundation at http://hbase.apache.org/.

In various embodiments, a search platform 306 may be maintained on DFS 302. Search platform 306 may provide distributed indexing and load balancing to support fast and reliable search results. For example, search platform 306 may comprise a Solr® search platform as described and made available by the Apache Software Foundation at http://lucene.apache.org/solr/.

In various embodiments, a data warehouse 314 such as Hive® may be maintained on DFS 302. The data warehouse 314 may support data summarization, query, and analysis of warehoused data. For example, data warehouse 314 may be a Hive® data warehouse built on Hadoop® infrastructure. A data analysis framework 310 may also be built on DFS 302 to provide data analysis tools on the distributed system. Data analysis framework 310 may include an analysis runtime environment and an interface syntax such similar to those offered in the Pig platform as described and made available by the Apache Software Foundation at https://pig.apache.org/.

In various embodiments, a cluster computing engine 312 for high-speed, large-scale data processing may also be built on DFS 302. For example, cluster computing engine 312 may comprise an Apache Spark™ computing framework running on DFS 302. DFS 302 may further support a MapReduce layer 316 for processing big data sets in a parallel, distributed manner to produce records for data storage formats 301. For example, MapReduce layer 316 may be a Hadoop® MapReduce framework distributed with the Hadoop® HDFS as specified by the Apache Software Foundation at http://hadoop.apache.org/docs/. The cluster computing engine 312 and MapReduce layer 316 may ingest data for processing, transformation, and storage in data storage formats 301 using the distributed processing and storage capabilities of DFS 302.

In various embodiments, DFS 302 may also support a table and storage management layer 308 such as, for example, an HCatalog installation. Table and storage management layer 308 may provide an interface for reading and writing data for multiple related storage formats. Continuing the above example, an HCatalog installation may provide an interface for one or more of the interrelated technologies described above such as, for example, Hive®, Pig, Spark®, and Hadoop® MapReduce.

In various embodiments, DFS 302 may also include various other data storage formats 318. Other data storage formats 318 may have various interface languages with varying syntax to read and/or write data In fact, each of the above disclosed storage formats may vary in query syntax and interface techniques. Virtualized database structure 320 may provide a uniform, integrated user experience by offering users a single interface point for the various different data storage formats 301 maintained on DFS 302. Virtualized database structure 320 may be a software and/or hardware layer that makes the underlying data storage formats 301 transparent to client 322 by providing variables on request. Client 322 may request and access data by requesting variables from virtualized database structure 320. Virtualized database structure 320 may then access the variables using the various interfaces of the various data storage formats 301 and return the variables to client 322.

In various embodiments, the data stored using various above disclosed data storage formats 301 may be stored across data storage formats 301 and accessed at a single point through virtualized database structure 320. The variables accessible through virtualized database structure 320 may be similar to a column in a table of a traditional RDBMS. That is, the variables identify data fields available in the various data storage formats 301.

In various embodiments, variables may be stored in a single one of the data storage formats 301 or replicated across numerous data storage formats 301 to support different access characteristics. Virtualized database structure 320 may comprise a catalog of the various variables available in the various data storage formats 301. The cataloged variables enable BDMS 300 to identify and locate variables stored across different data storage formats 301 on DFS 302. Variables may be stored in at least one storage format on DFS 302 and may be replicated to multiple storage formats on DFS 302. The catalog of virtualized database structure 320 may track the location of a variable available in multiple storage formats.

The variables may be cataloged as they are ingested and stored using data storage formats 301. The catalog may track the location of variables by identifying the storage format, the table, and/or the variable name for each variable available through virtualized database structure 320. The catalog may also include metadata describing what the variables are and where the variables came from such as data type, original source variables, timestamp, access restrictions, sensitivity of the data, and/or other descriptive metadata. For example, internal data and/or PII may be flagged as sensitive data subject to access restrictions by metadata corresponding to the variable containing the internal data and/or PII. Metadata may be copied from the storage formats 301 or generated separately for virtualized database structure 320.

In various embodiments, virtualized database structure 320 may provide a single, unified, and virtualized data storage format that catalogues accessible variables and provides a single access point for records stored on data storage formats 301. Client 322 (which may operate using similar hardware and software to client 210 of FIG. 1) may access data stored in various data storage formats 301 via the virtualized database structure 320. In that regard, virtualized database structure 320 may be a single access point for data stored across the various data storage formats 301 on DFS 302.

In various embodiments, virtualized database structure 320 may store and maintain the catalog of variables including locations and descriptive metadata, but virtualized database structure 320 may not store the actual data contained in each variable. The data that fills the variables may be stored on DFS 302 using data storage formats 301. Virtualized database structure 320 may enable read and write access to the data stored in data storage formats 301 without a client system having knowledge of the underlying data storage formats 301.

Referring now to FIG. 4, a behavior monitoring system 400 may run on data storage system 110 as a separate computing device or as an application running on data storage system 110. As users access data from user device 102, production application 104, application servers 106, and/or other computing devices 108 in communication with storage system 100, behavior monitoring system 400 may detect and evaluate the access.

Behavior monitoring system 400 may identify and/or collect data sources (Block 402). Data sources may be log files (UNIX, DB, etc.). The system may collect and stores the sources. Data sources may include an access rights database (ARD), file and/or folder operation logs, data service logs, file system logs, CDM operational metadata logs, celebrity and prominent individuals data, employee data, open network confidentiality operating principles (ONCOP) rules and data, PII data, or other types of data. The identified data sources may contain data suitable for access monitoring. For example, a user that accesses data related to a prominent individual may have appropriate access permissions for the data, but may be inappropriately singling out records relating to the prominent individual. These data types may be susceptible to misuse by an individual. Behavior monitoring system 400 may detect misuse of the identified data by individuals, as described in detail below.

Behavior monitoring system 400 may process and/or organize data (Block 404). The system may parse the files for usable info (e.g. user queries and user identification info) to separate the useable info from other status messages. The system may also store information based on user, group, etc. for later access. Processing may include scanning identified data to determine which data sources contain sensitive data at a column or table level. Processing may also include identifying the type of sensitive data and sensitivity levels at a column or table level. The data may be stored in log files at the system and/or database level. This data may be exported into a format suitable for queries such as a relational database. The data may be standardized, parsed and stored in a relational database, such as MySQL, for example. This data reading processes may be aided by textual analysis and standardization, allowing an automated process to determine the operation type (e.g., select query, access type) and store as appropriate.

Behavior monitoring system 400 may analyze and/or create signals for monitoring (Block 406). Events may be identified and cataloged to generate signals. Signal analysis may be internal or external. Signals may include rules or indicators that signal potential misuse. For example, a signal may include a query that selects a single row based on account number, name, or ssn. A query that selects PII data may also be a signal. Although any query or output file may serve as a signal, unique signals often warrant closer investigation. Signals may be analyzed and created by a variety of methods. For example, signals may be generated using expert input. Specific signals may be defined by experts in order to aid in detection. While single queries may not act as behavior signals, an amalgamation of those queries may be used to indicate behavior that can then be classified as normal or suspect. The signals may thus act as outlier behavioral patterns identifiable against the corpus of normal behavior for a team, group, organization, etc.

Behavior monitoring system 400 may derive behavioral patterns (Block 408). Behavior monitoring system 400 may organize behavior (i.e., events and/or signals) into sequences and patterns. For example, the system may retrieve an individual user's data for manual review. The system derives patterns of behavior that may or may not be acceptable for a given user or role for a later determination as to propriety. Behavior patterns may be identified by evaluating the signals from block 406. Patterns may be identified based similar data access repeated by entities such as users, groups, applications, teams, and/or devices having the same or similar characteristics. For example, Behavior monitoring system 400 may identify that several users on a development team may regularly query data sets with 10,000 to 100,000 records. Behavior monitoring system 400 may derive the behavioral pattern that users from the development team query data sets with 10,000 to 100,000 records. The behavioral pattern is a rule indicative of expected data access behavior, unexpected data access behavior, lack of data access behavior, timing of data access behavior and/or high-risk data access behavior. The number of behavioral patterns identified as associated with an entity may range from 0 rules where no behavior is identified to numerous rules for entities that regularly access data and/or have access to sensitive data. The behavioral patterns may be written by experts and entered into the system, the rules may be a product of machine learning, or the rules may be some combination of expert entries and machine learned entries.

In order to successfully issue a query, a user has access rights to the queried data. In response to issuing a query, the querying user's identifier is logged as part of the query log. Obtaining the behavior information from a query may be performed by semantic analysis of a query (e.g., performed prior to execution) and by metadata produced by successful execution of the query (e.g., number of records returned, number of files affected). An expert may write a behavior pattern through look-alike modeling or triggers based on specific access combinations, for example. These can be representations of a finite-state machine or a decision tree, which can be represented as an XML structure, a JSON object, or other structured data format.

Behavior monitoring system 400 may create behavioral models (Block 410). The system may use the behavioral models to identify behavior as acceptable, expected, prohibited, or any other desired classification. The guidelines may be created and stored for future analysis and reference. Behavioral models may be generated for each user of data storage system 110. A behavioral model may be a collection of behavioral patterns that are expected for a given entity. Thus, each user, group, team, or other entity may have a varying set of rules from other entities. The behavioral model defines the expected and/or appropriate access behavior of an individual. Highly evolved behavioral models containing numerous rules may be unique on an entity level. Models may be updated based upon new data access behavior that behavior monitoring system 400 observes.

Behavioral models may be constructed by analyzing and generalizing the behavior exhibited by users and groups. Behavior monitoring system 400 may analyze queries, file accesses, and other activity by users and groups to identify behavioral models. User behavior can be identified as events, which may be arranged in sequences and analyzed as a distribution of behavior. Unusual behaviors may be event sequences that are atypical within a group or by a particular user. Those behavior patterns can be stored in a variety of ways depending on specific implementation (e.g. XML DAG sequences, database records, JSON records in a NoSQL database, etc.).

Behavior monitoring system 400 may compare user activity to the behavioral models to detect activity that is out of character and/or inappropriate (Block 412). User activities generate new data, which may be ingested into the system at block 402. The data can help identify new data sources for comparison to a model to flag inappropriate behavior. The system compares activity to models that are groupings of users that fall into similar patterns of usage. In response to a user matching with a model based on similar characteristics and behavior, the user behavior may be identified as appropriate or suspect. Techniques for grouping users to check behavior against those models may include be kNN (nearest neighbor clustering), look-alike modeling, cover trees, or other suitable modeling methods.

Each user may have their own behavioral model, and behavior monitoring system 400 may detect each user's data access activity and compare the activity with their behavioral model. Activity that does not match rules for acceptable user behavior may indicate inappropriate access. Similarly, activity that does match rules for inappropriate behavior indicates inappropriate access.

Behavior monitoring system 400 may summarize findings and/or generate reports (Block 414). The reports may report on user behavior. Reporting may be done through a query of the behavioral database as compared to patterns, where behavior that is flagged due to look-alike with a specific model can be identified and reported. Behavior monitoring system 400 may report results of analysis by email, dashboard, sms, or other suitable communication channels. Behavior monitoring system 400 may trigger remediation activity as appropriate in response to detecting user activity that falls outside the range of acceptable activity as defined by that user's behavioral model.

Behavior monitoring system 400 may trigger remediation activity (Block 416). Remediation activity may engage users to verify behavior and patterns and determine if there is justification for activity. Remediation activity may identify additional data sources for review and analysis. Remediation activity may include manual verification of the triggering behavior and further investigation.

With reference to FIG. 5, a process 500 is shown for monitoring data access behavior on data storage system 110, in accordance with various embodiments. Data storage system 110 may derive a behavioral pattern based on at least one of historic data access by a user or expected data access by the user (Block 502). The behavioral pattern may be derived as described above with reference to FIG. 4. The data storage system 110 may also generate a behavioral model for the user based on the behavioral pattern for the user (Block 504). An expert-generated behavioral pattern for the user may be input into the data storage system, and the behavioral model for the user may be generated using the derived behavioral pattern and/or the expert-generated behavioral pattern. Expert users may input patterns and rules through an interface, such as a GUI for example, that allows them to define those patterns using a “rule builder” application, or editing the rules as represented by the system (such as with XML or JSON), or through program code.

In various embodiments, data storage system 110 may further detect a data access activity by the user (Block 506). The data storage system may identify a data source containing sensitive data and analyze access to the data source containing sensitive data to detect the data access activity. Data storage system 110 may compare the data access activity to the behavioral model to determine the data access activity is unusual for the user (Block 508). Data storage system 110 may also trigger a remediation action in response to determining the data access activity is unusual for the user. Data storage system 110 may report results of analysis by at least one of an email, a dashboard, or an sms message.

Access may be detected through user logging, command logging, or query logging, for example. Comparison of behavior to models includes evaluating a user's queries against those that are expected by the role and team (e.g. if a team is always querying 10,000 rows at a time and a specific team member is making specialized queries, that behavior may be flagged). Outlier remediation may be defined in advance in accordance with a predetermined policy. Remediation activity may be defined by a lookup table of actions, for example. Remediation activity may also be defined as the number of levels of escalation for an event (e.g. some events require contact of a user's manager, others require going one or more levels above).

The systems and methods herein can detect user activity in accessing data and compare the activity to user models to detect unusual or unwarranted activity. By monitoring user behavior, the present systems can identify individuals who are misusing the data to which they have access, including when that misuse involves sensitive data. Behavioral modeling and analysis results in detection of unwarranted access to sensitive data. The model-based process enables evaluation of all data access hosted by a monitored data storage system. Subsets of data access may also be monitored based on user and/or data type, for example.

For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

In various embodiments, the system and method may include alerting a subscriber when their computer is offline. The system may include generating customized information and alerting a remote subscriber that the information can be accessed from their computer. The alerts are generated by filtering received information, building information alerts and formatting the alerts into data blocks based upon subscriber preference information. The data blocks are transmitted to the subscriber's wireless device which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email) to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of retaining control over customers during affiliate purchase transactions, using a system for co-marketing the “look and feel” of the host web page with the product-related content information of the advertising merchant's web page. The system can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link is not transported from the host web page to the merchant's web page, but instead is redirected to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

Systems, methods and computer program products are provided. In the detailed description herein, references to “various embodiments”, “one embodiment”, “an embodiment”. “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data, a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS® NT®, WINDOWS® 95/98/2000®, WINDOWS® XP®, WINDOWS® Vista®, WINDOWS® 7®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet account), a communications port, a Personal Computer Memory Account International Association (PCMCIA) slot and account, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see. e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

Any databases discussed herein may include relational, nonrelational, hierarchical, graphical, or object-oriented structure and/or any other database configurations including various big data products available from the Apache Software Foundation as described above. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP. SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE®ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.192.225). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998): (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment: for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
deriving, by a data storage system, a behavioral pattern based on at least one of historic data access by a user or expected data access by the user;
generate, by the data storage system, a behavioral model for the user based on the behavioral pattern for the user;
detecting, by the data storage system, a data access activity by the user;
comparing, by the data storage system, the data access activity to the behavioral model to determine the data access activity is unusual for the user; and
triggering, by the data storage system, a remediation action in response to determining the data access activity is unusual for the user.

2. The method of claim 1, further comprising identifying, by the data storage system, a data source containing sensitive data.

3. The method of claim 2, further comprising analyzing, by the data storage system, access to the data source containing the sensitive data to detect the data access activity.

4. The method of claim 1, further comprising inputting into the data storage system an expert-generated behavioral pattern for the user.

5. The method of claim 4, wherein the behavioral model for the user is based on the derived behavioral pattern and the expert-generated behavioral pattern.

6. The method of claim 1, further comprising reporting, by the data storage system, a result of analysis by at least one of an email, a dashboard, or an sms message.

7. The method of claim 1, further comprising:
deriving, by the data storage system, a group behavioral pattern based on data access by a group of users; and
generating, by the data storage system, the behavioral model for the user based on the behavioral pattern for the user and the group behavioral pattern.

8. A computer-based system, comprising:
a processor;
a tangible, non-transitory memory configured to communicate with the processor, the tangible, non-transitory memory having instructions stored thereon that, in response to execution by the processor, cause the processor to perform operations comprising:
deriving, by the processor, a behavioral pattern based on at least one of historic data access by a user or expected data access by the user;
generate, by the processor, a behavioral model for the user based on the behavioral pattern for the user;
detecting, by the processor, a data access activity by the user;
comparing, by the processor, the data access activity to the behavioral model to determine the data access activity is unusual for the user; and
triggering, by the processor, a remediation action in response to determining the data access activity is unusual for the user.

9. The computer-based system of claim 8, further comprising identifying, by the processor, a data source containing sensitive data.

10. The computer-based system of claim 9, further comprising analyzing, by the processor, access to the data source containing the sensitive data to detect the data access activity.

11. The computer-based system of claim 8, further comprising inputting into the processor an expert-generated behavioral pattern for the user.

12. The computer-based system of claim 11, wherein the behavioral model for the user is based on the derived behavioral pattern and the expert-generated behavioral pattern.

13. The computer-based system of claim 8, further comprising reporting, by the processor, a result of analysis by at least one of an email, a dashboard, or an sms message.

14. The computer-based system of claim 8, further comprising:
deriving, by the processor, a group behavioral pattern based on data access by a group of users; and
generating, by the processor, the behavioral model for the user based on the behavioral pattern for the user and the group behavioral pattern.

15. An article of manufacture including a non-transitory, tangible computer readable storage medium having instructions stored thereon that, in response to execution by a data storage system, cause the data storage system to perform operations comprising:
deriving, by the data storage system, a behavioral pattern based on at least one of historic data access by a user or expected data access by the user;
generate, by the data storage system, a behavioral model for the user based on the behavioral pattern for the user;
detecting, by the data storage system, a data access activity by the user;
comparing, by the data storage system, the data access activity to the behavioral model to determine the data access activity is unusual for the user; and
triggering, by the data storage system, a remediation action in response to determining the data access activity is unusual for the user.

16. The article of claim 15, further comprising identifying, by the data storage system, a data source containing sensitive data.

17. The article of claim 16, further comprising analyzing, by the data storage system, access to the data source containing the sensitive data to detect the data access activity.

18. The article of claim 15, further comprising inputting into the data storage system an expert-generated behavioral pattern for the user, wherein the behavioral model for the user is based on the derived behavioral pattern and the expert-generated behavioral pattern.

19. The article of claim 15, further comprising reporting, by the data storage system, a result of analysis by at least one of an email, a dashboard, or an sms message.

20. The article of claim 15, further comprising:
deriving, by the data storage system, a group behavioral pattern based on data access by a group of users; and
generating, by the data storage system, the behavioral model for the user based on the behavioral pattern for the user and the group behavioral pattern.
